(19) United States
(12) Patent Application Publication
(10) Pub. No.: US 2019/0106085 A1
(43) Pub. Date: Apr. 11, 2019

(54) SYSTEM AND METHOD FOR AUTOMATED DECONTAMINATION OF VEHICLE OPTICAL SENSOR LENS COVERS

(71) Applicant: GM GLOBAL TECHNOLOGY OPERATIONS LLC, Detroit, MI (US)

(72) Inventors: Brent N. Bacchus, Sterling Heights, MI (US); Shuqing Zeng, Sterling Heights, MI (US); Jinsong Wang, Troy, MI (US); Upali P. Mudalige, Oakland Township, MI (US); Norman J. Weigert, Whitby (CA); Rana Dastgir, Scarborough (CA); Michael D. Alarcon, Markham (CA)

(73) Assignee: GM GLOBAL TECHNOLOGY OPERATIONS LLC, Detroit, MI (US)

(21) Appl. No.: 15/728,677

(22) Filed: Oct. 10, 2017

(51) Int. Cl. B60S 1/56; B60S 1/54; B60S 1/46; B60S 1/04; B60S 1/62

(52) U.S. Cl. CPC B60S 1/56; B60S 1/54; B60S 1/62; B60S 1/04; B60S 1/46

(57) ABSTRACT

Methods and apparatus are provided for cleaning a sensor lens cover for an optical vehicle sensor. The method includes monitoring the sensor lens cover for a contaminant obstructing at least a portion of the sensor lens cover and determining the presence of the commandant and a contaminant type using information provided by one or more vehicle sensors. A cleaning modality selected based the contaminant type is activated and it is determined whether the cleaning modality has removed the contaminant from the sensor lens cover.

### INTRODUCTION

The present disclosure generally relates to optical vehicle sensors having a sensor lens cover, and more particularly relates to automated cleaning of the sensor lens cover.

Contemporary vehicles commonly employ optical sensors to facilitate operation of the vehicle. Examples of optical sensors include camera systems, video systems and light detection and ranging (LIDAR) systems. Typically, these optical systems are positioned behind a sensor lens cover that protects the optical sensor and allows the vehicle designer to blend the sensor lens cover into the appearance of the vehicle. However, it is common for sensor lens covers to become obstructed (or at least partially obstructed) by contaminants (e.g., dirt, snow or rain) that may reduce the effectiveness of the optical sensor. Cleaning systems may be employed for the sensor lens cover, however, the cleaning process itself temporarily restricts use of the optical sensor.

Accordingly, it is desirable to decontaminate a sensor lens cover using an automated cleaning system. In addition, it is desirable to have the automated cleaning system function only when needed and responsive to the type of contaminant on the sensor lens cover to promote the most effective cleaning. Furthermore, other desirable features and characteristics of the present invention will become apparent from the subsequent detailed description of the invention and the appended claims, taken in conjunction with the accompanying drawings and the background of the invention.

### SUMMARY

A method for cleaning a sensor lens cover for an optical vehicle sensor is provided. The method includes monitoring the sensor lens cover for a contaminant obstructing at least a portion of the sensor lens cover and determining the presence of the contaminant and a contaminant type using information provided by one or more vehicle sensors. A cleaning modality selected based the contaminant type is activated and it is determined whether the cleaning modality has removed the contaminant from the sensor lens cover.

In another aspect of the disclosure, the cleaning modality is reapplied at an increased intensity when the processor determines that the contaminant has not been removed from the sensor lens cover.

In another aspect of the disclosure, a second cleaning modality different from the initial cleaning modality is activated when it is determined that the contaminant has not been removed from the sensor lens cover after the completion of the initial cleaning modality.

In another aspect of the disclosure, the sensor lens cover is partitioned in to a plurality of cells and it is determined which of the plurality of cells are affected by the contaminant.

In another aspect of the disclosure, each of the plurality of cells has a respective cell weight assigned and the respective cell weight for any of the plurality of cells that cannot be cleaned by the cleaning modality is reduced.

In another aspect of the disclosure, any of the plurality of cells having a cell weight below a threshold is ignored and an alert is provided that the sensor lens cover requires service.

In another aspect of the disclosure, the vehicle sensors providing the information that the processor uses to determine the contaminant type comprise one or more of the following group of vehicle sensors: weather, droplet detector, windshield wiper status, speed and washer fluid levels.

In another aspect of the disclosure, the cleaning modality selected by the processor comprises one or more of the following group of cleaning modalities: pressurized air, pressurized fluid, mechanical wiping action, centrifugal force and ultrasonic vibration.

In another aspect of the disclosure, the cleaning modality applied is ultrasonic vibration or pressurized air when the processor determines the contaminant type to be liquid and pressurized fluid when the processor determines the contaminant type to be solid.

A system for cleaning a sensor lens cover for an optical vehicle sensor is provided. The system includes a plurality of vehicle sensors, each providing respective sensor information to a processor, and one or more contaminant detectors provide contaminant information to the processor enabling the processor to detect presence of a contaminant on at least a portion of the sensor lens cover. The system also includes one of one or more cleaning systems to activate a respective cleaning modality for the sensor lens cover. The processor determines a location of the contaminant on the sensor lens cover and a contaminant type using the sensor information and the contaminant information, and activates a selected cleaning system depending upon the contaminant type and determines whether the contaminate has been removed after the completion of the cleaning modality.

In another aspect of the disclosure, the processor reactivates the selected cleaning system to reapply the cleaning modality at an increased intensity when the processor determines that the contaminant has not been removed from the sensor lens cover.

In another aspect of the disclosure, the processor activating a second cleaning system different from the selected cleaning system or a combination of cleaning systems when the processor determines that the contaminant has not been removed from the sensor lens cover.

In another aspect of the disclosure, the sensor lens cover is partitioned into a plurality of cells and the processor further determines which of the plurality of cells are affected by the contaminant.

In another aspect of the disclosure, each of the plurality of cells has a respective cell weight assigned by the processor and the processor reduces the respective cell weights for any of the plurality of cells that cannot be cleaned by the cleaning modality.

In another aspect of the disclosure, the processor ignores any of the plurality of cells having a cell weight below a threshold and the processor provides an alert that the sensor lens cover requires service.

In another aspect of the disclosure, the plurality of vehicle sensors providing the respective sensor information that the processor comprise one or more of the following group of vehicle sensors: weather, droplet detector, windshield wiper status, speed and fluid levels.

In another aspect of the disclosure, the cleaning modality provided by the selected cleaning system comprises one of the following group of cleaning modalities: pressurized air, pressurized fluid, mechanical wiping action, centrifugal force and ultrasonic vibration.

In another aspect of the disclosure, the selected cleaning system provides ultrasonic vibration or pressurized air when the processor determines the contaminant type to be liquid and pressurized fluid when the processor determines the contaminant type to be solid.

A system is provided. The system includes an optical vehicle sensor having a sensor lens cover partitioned into a plurality of cells and a plurality of vehicle sensors each providing respective sensor information to a processor. The system also includes one or more contaminant detectors providing contaminant information to the processor enabling the processor to detect presence of a contaminant on at least some of the cells of the sensor lens cover and determine a contaminant type using the sensor information. The system further includes one or more cleaning systems coupled to the processor and responsive to the processor to activate a respective cleaning modality for the sensor lens cover. In this way, the processor activates a selected cleaning system depending upon the contaminant type and determines whether the contaminate has been removed after the completion of the cleaning modality.

In another aspect of the disclosure, the processor reactivates the selected cleaning system to reapply the cleaning modality at an increased intensity when the processor determines that the contaminant has not been removed from the sensor lens cover, and the processor activates a second cleaning system different from the selected cleaning system or a combination when the processor determines that the contaminant has not been removed from the sensor lens cover by reapplication of the cleaning modality.

### BRIEF DESCRIPTION OF THE DRAWINGS

The present invention will hereinafter be described in conjunction with the following drawing figures, wherein like numerals denote like elements, and

FIG. 1A is an illustration of a vehicle employing a LIDAR system having an un-contaminated sensor lens cover;

FIG. 1B is an illustration of a vehicle employing a LIDAR system having a partially contaminated sensor lens cover;

FIG. 2 is a block diagram of the optical sensor lens cover cleaning system in accordance with an embodiment;

FIG. 3 is a block diagram of the decision function of FIG. 2 in accordance with an embodiment;

FIG. 4 is a flow diagram illustrating the method performed by the optical sensor lens cleaning system of FIG. 2 in accordance with an embodiment;

FIGS. 5A-B is an illustration of one technique for detecting fluid contamination in accordance with an embodiment;

FIGS. 6A-E is an illustration of one technique for detecting solid contamination in accordance with an embodiment; and

FIGS. 7-8 are illustrations of cleaning systems and modalities in accordance with an embodiment.

### DETAILED DESCRIPTION

The following detailed description is merely exemplary in nature and is not intended to limit the disclosure or the application and uses of the disclosure. Furthermore, there is no intention to be bound by any theory presented in the preceding background or the following detailed description.

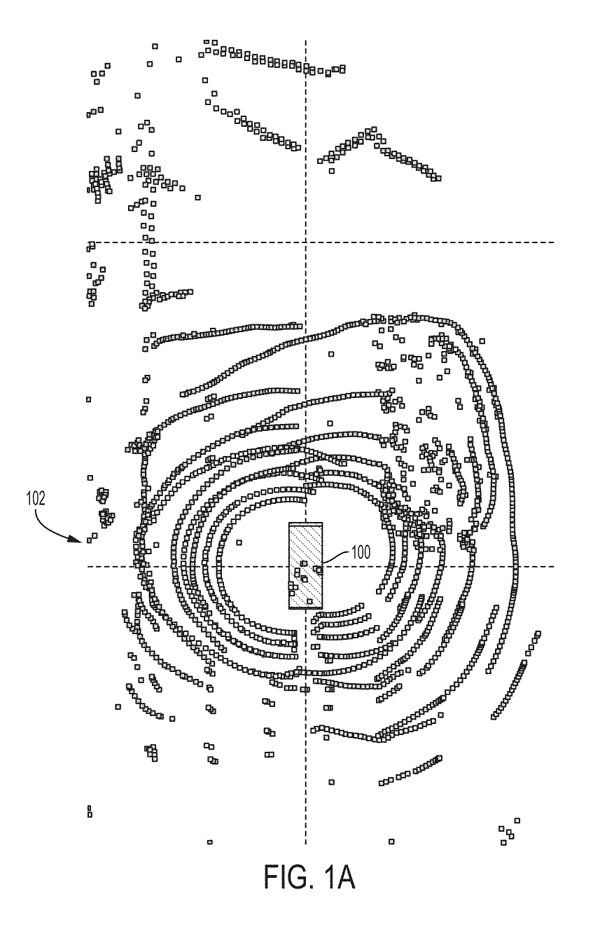

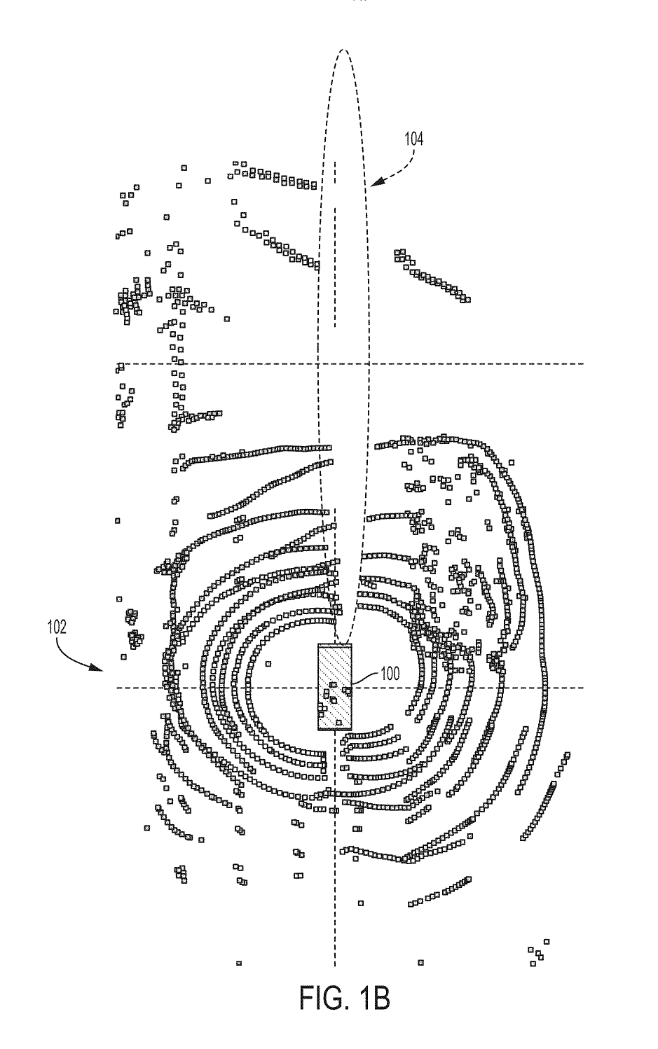

FIG. 1A illustrates a vehicle 100 utilizing a LIDAR system and the resulting LIDAR detection pattern 102. As can be seen, the LIDAR detection pattern 102 is substantially uniform extending around the vehicle 100. This results from the LIDAR sensor lens cover being clear and uncontaminated. In FIG. 1B, the LIDAR sensor lens cover has been partially contaminated resulting in the LIDAR detection pattern 102 having an occlusion 104 in the detection pattern 102. In the circumstance of FIG. 1B, the LIDAR sensor lens cover would benefit from cleaning, however, the process of cleaning will itself temporarily obscure the lens cover. Should the contaminant not be removed by the cleaning process, repeated attempts at cleaning will only consume cleaning resources and repeatedly interrupt the utility of the LIDAR system.

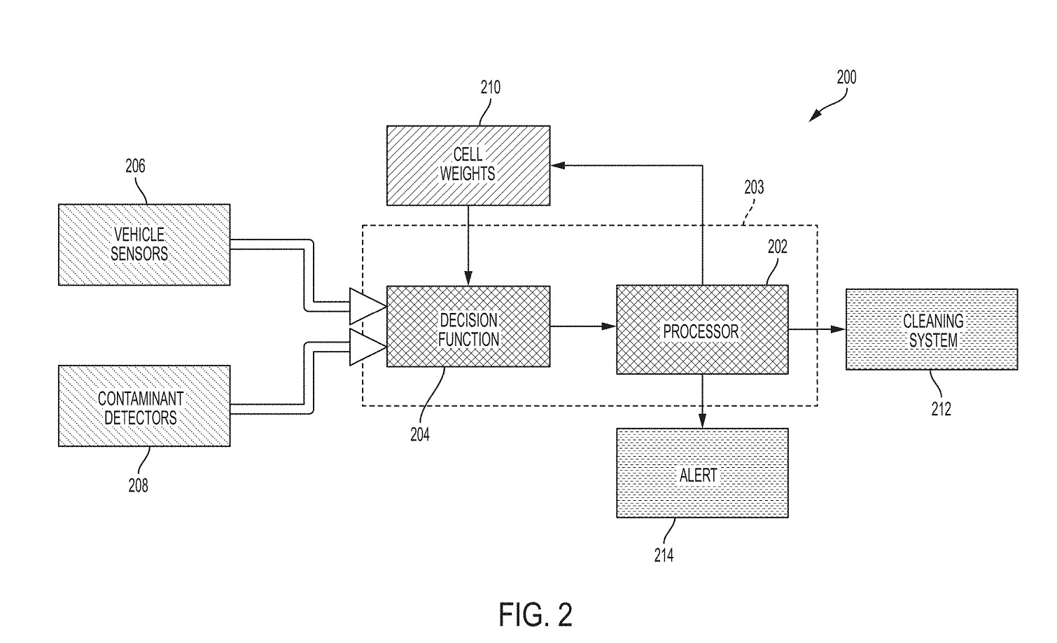

FIG. 2 is a block diagram of the automated optical sensor lens cleaning system 200 in accordance with one non-limiting embodiment. As will be discussed below, the sensor lens cleaning system of the present disclosure partitions the sensor lens cover into a plurality of cells and utilizes contaminant detectors and other vehicle sensors to determine the location and type of contaminant on the sensor lens cover. To clean the sensor lens cover, a cleaning system having a cleaning modality selected to be effective for cleaning the type of contaminant on the sensor lens cover is activated. As used herein, the phrase “cleaning modality” means a process, technique or method for attempting to remove or reduce the amount of contaminant present on the sensor lens cover. Non-limiting examples of cleaning modalities utilized by the present disclosure include pressurized air, pressurized fluid, ultrasonic vibration, centrifugal force and mechanical wiping action. Additionally, some embodiments of the present disclosure assign weights to the plurality of cells representing the sensor lens cover. If one or more cells cannot be effectively cleaned of the contaminant, a weight value assigned to that cell is reduced so that continued detection of contaminant in that cell does not re-trigger the cleaning system 200. This operates to both save cleaning resources and to keep the optical sensor in service as much as possible. In the event that a contaminant affecting one or more cells cannot be removed after multiple cleaning attempts, the weight value applied to such cell(s) can be reduced to the point that that cell is no longer considered in determining whether to clean the sensor lens cover. In this case, an alert will be provided to the vehicle operator that service to the sensor lens cover is needed as it cannot be cleaned by the cleaning system 200.

As shown in FIG. 2, the automated optical sensor lens cleaning system 200 is controlled by a processor or controller 202 that receives cleaning decision from a decision function or algorithm 204. In some embodiments, the decision function 204 can be integrated into the processor 202 as indicated at 203. Decision function 204 receives various sensor information inputs from vehicle sensors 206 throughout the vehicle. Non-limiting examples of such sensors include speed sensors, whether sensors, water droplets sensors, windshield wiper status sensors, gear position (e.g., forward or reverse) or other sensors providing information useful to a cleaning system in any particular embodiment. The vehicle sensors 206 provide information that aid in the decision function 204 determination of the type of contaminant obscuring all or some portion of the sensor lens cover. Additionally, contaminant detectors 208 provide the decision function 204 with information regarding the location of the contaminant on the sensor lens cover. As noted above, the sensor lens cover is partitioned into a plurality of cells so that the decision function 204 can determine which cell or cells are affected by the presence of the contaminant. This provides an advantage for contaminants that cannot be fully cleaned by the cleaning system 200 by having the cell weights 210 reduced for those cells so that the continued detection of contaminants in those cells does not repeatedly re-trigger application of the cleaning system 200. When the decision function 204 determines that the sensor lens cover needs to be cleaned, and has determined the type of contaminant present on the sensor lens cover, the processor 200 activates one or more cleaning systems 212 in an attempt to remove the contaminant from the sensor lens cover. In a non-limiting example, should the vehicle sensor 206 indicate that it is raining, and the contaminant detector determines the location of water droplets on the sensor lens cover utilizing blob analysis, the processor 202 may activate an ultrasonic cleaning system that vibrates the sensor lens cover in order to break the surface tension of the water droplets on the sensor lens cover to have them removed by virtue of gravity. Or initiate the release of pressurized air to blow off the water droplets. In the event that one or more cells of the sensor lens cover cannot be cleared the processor 202 provides an alert 214 to the vehicle operator indicating that services required for the sensor lens cover in that it cannot be cleared by the cleaning system 200.

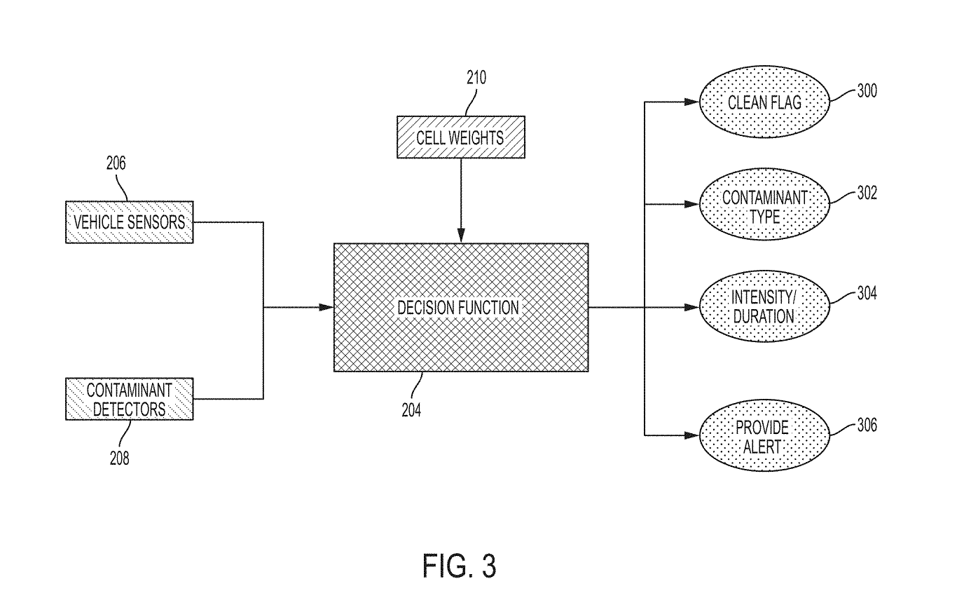

With continued reference to FIG. 2, FIG. 3 is a block diagram of the decision function 204 and the information it provides to the processor 202. When the decision function 204 detects contaminants in one or more cells of the sensor lens cover, it indicates to the processor 202 that the cleaning system should be activated by setting the clean flag 300. Additionally, the contaminant type 302 determined by the decision function 204 is provided to the processor. Based upon the contaminant type, the processor 202 will determine which cleaning system will be selected to apply a cleaning modality for the sensor lens cover. Depending upon the amount or location of the contaminant, the decision function 204 also provides an intensity and duration recommendation 304 for cleaning operation to remove the contaminant. For example, if only a few cells are obstructed by dirt a pressurized cleaning fluid may be applied for a short duration, but if most cells of the sensor lens cover are affected by dirt the pressurized cleaning fluid may be applied for a longer time period. Also, if the decision function 204 determines that one or more cells of the sensor lens cover cannot be cleaned a recommendation to provide an alert 306 to the operator the vehicle can be provided so that the processor 202 can activate the alert 214.

As will be appreciated, the decision function 204 may be realized as a decision tree or logistic regression and may be trained using manual conditions and training data gathered over time. As a non-limiting example, the decision function may be expressed as: if (RAINING and WIPERS ON and DROPLET DETECTED and CELL WEIGHT >0), then, (TRUE, WATER, 10 s, NO), where, “true” represents the clean flag output 300; “water” represents the contaminant type output 302; “10 s” represents the intensity/duration output 304 and “no” represents the provide alert output 306. As another non-limiting example, the decision function may be expressed as: if (RAINING and FLUID CAPACITY <0.2 and DROPLET DETECTED and WEIGHT <0.1), then, (FALSE, WATER, 0, NO) where, “false” represents the clean flag output 300; “water” represents the contaminant type output 302; “0” represents the intensity/duration output 304 and “no” represents the provide alert output 306.

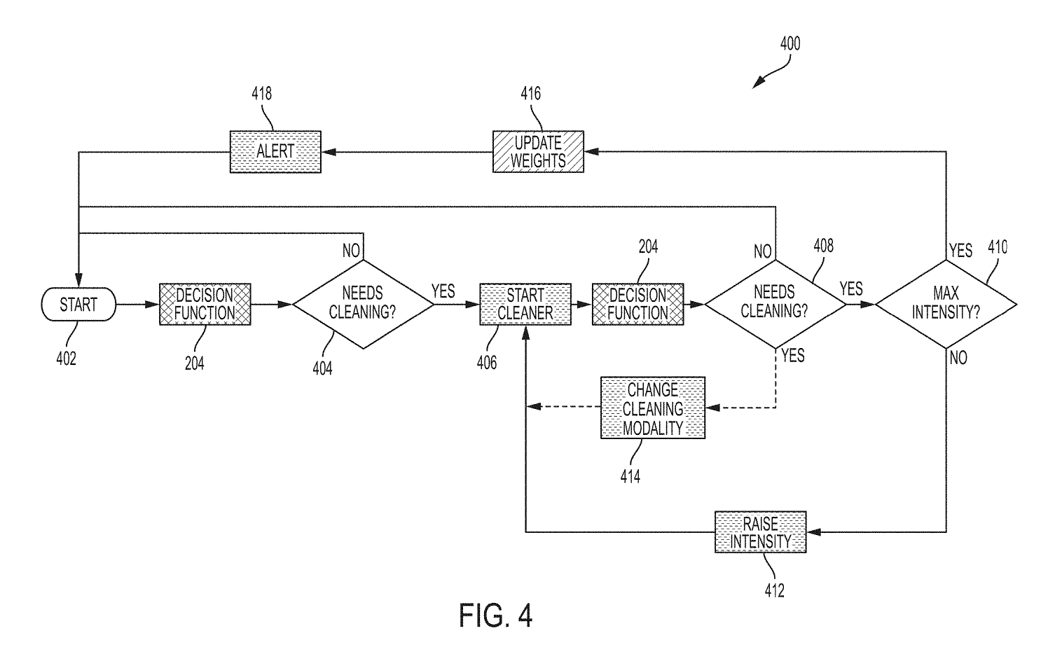

With continued reference to FIG. 2 and FIG. 3, FIG. 4 is a flow diagram illustrating an exemplary embodiment of a cleaning method 400 of the cleaning system 200. The method 400 begins at block 402. For ease of understanding, preliminary steps such as system activation, calibration or determination of initial conditions have been omitted from FIG. 4. As discussed above, decision function 204 processes the inputs receives from the vehicle sensors and contaminant detectors and will make a determination whether the sensor lens cover needs cleaning in block 404. If so, a cleaning system is selected based upon the contaminant type to provide an effective cleaning modality to the sensor lens cover at block 406. After completing the cleaning modality selected, the decision function 204 again examines the sensor lens cover to determine whether the contaminant has been cleared. If so, the routine returns to block 402. However, if block 408 determines the sensor lens cover still requires cleaning, block 410 determines whether the maximum intensity of the cleaning modality has been utilized. If not, the cleaning modality intensity can be raised in block 412 and the cleaning process of block 406 reactivated. Optionally, block 408 may determine to change the cleaning modality if the initial attempt has not cleared the contaminant. For example, if the decision function has determined that dirt is obstructing one or more cells of the sensor lens cover, and the application of pressurized cleaning fluid has not removed the dirt, the cleaning modality may be changed to employ mechanical action (e.g., activation of a wiper) to attempt to remove the dirt. However, if the determination of block 410 is that the maximum intensity of the cleaning modality has been reached, the cell weights of the sensor lens cover are updated. That is, the cell weight values of the sensor lens cover cells that cannot be cleaned are reduced so as not to have the continued presence of the contaminant in those cells retrigger application of the cleaning process 400. Conversely, cell weight values may be increased for cells that have been successfully cleaned by the cleaning system 200. This operates to conserve cleaning resources and keep the optical sensor in service to the extent possible. Also, an alert can be provided in block 418 to alert the vehicle operator that the sensor lens cover requires service to remove the contaminant and restore the optical sensor to full operation.

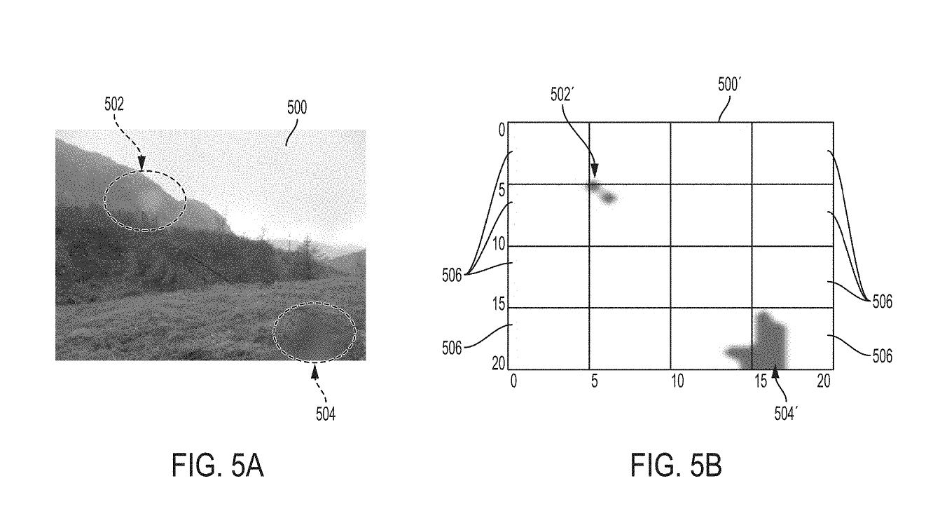

FIGS. 5A-5B illustrate a non-limiting example for how the contamination detectors 208 may determine the presence of water droplets on the sensor lens cover. In FIG. 5A, a frame 500 from a camera or video optical sensor shows the presence of water droplets as indicated at 502 and 504. As will be appreciated, using techniques such as blob analysis, Laplacian filtering or other techniques the contamination detectors 208 may determine the presence of water droplet contamination on the sensor lens cover. In FIG. 5B, the water droplet contamination 502′and 504′as seen by the contamination detectors 208 are illustrated. As noted above, the sensor lens cover 500′ is partitioned into a plurality of cells 506 so that the contamination detector 208 may determine the location of the contamination in reference to the affected cells. In the event the contamination cannot be removed by the application of one or more cleaning modalities, the weight value applied to the affected cells may be reduced to the point where contamination in those cells are ignored and an alert provided to the vehicle operator that the sensor lens cover requires service. In some embodiments, all of the cells of the sensor lens cover are considered equal or provided with equal initial condition weight values. In other embodiments, the central cells of the sensor lens cover are given preferential initial weight values or preference in cleaning determination. Such cell preference, or extent of cell preference, may be realized in any particular implementation by the cleaning system designer depending upon the sensor type, sensor location on the vehicle or vehicle system that the sensor is providing information to (e.g., braking system).

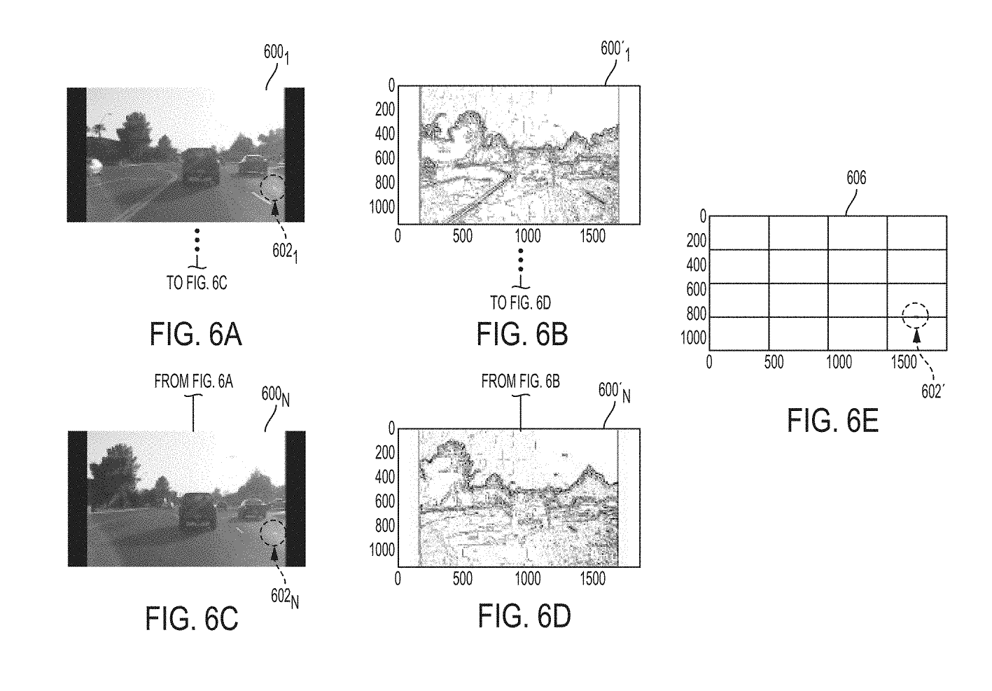

FIGS. 6A-6E, illustrate a non-limiting method for the contamination detectors to sense the presence of dirt on the sensor lens cover. In FIG. 6A, a video frame 6001 indicates the presence of a dirt particle 6021. By comparing successive video frames, it can be determined that the dirt particle 602N is present N frames later as shown by video frame 600N continuing to detect the presence of the dirt particle 602N. As will be appreciated, by applying threshold techniques to the video frames 6001 through 600N a contamination detector 208 can multiply and filter the threshold images 600′i through 600′N to produce the analyzed sensor cover frame 606 indicating the continued presence of dirt particle 602′ through N successive video frames. This would cause the decision function 204 to determine to initiate the cleaning process as discussed above in connection with FIG. 4.

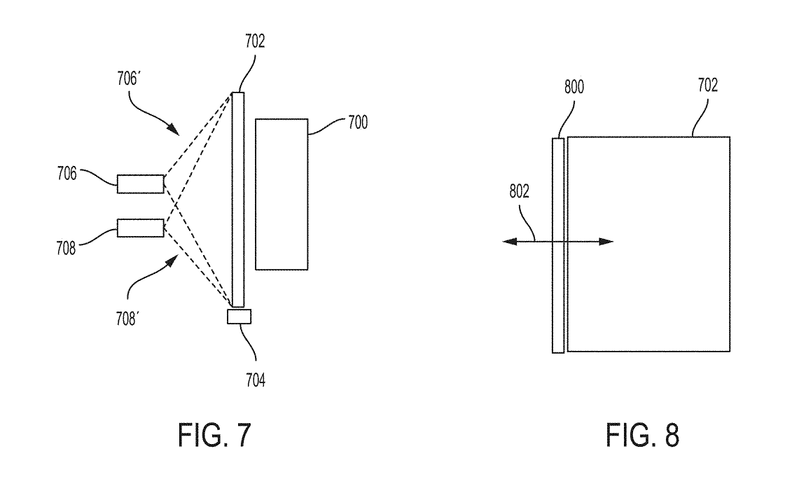

FIGS. 7-8 illustrate some non-limiting cleaning systems 212 that could be employed in any particular embodiment of the present disclosure. In FIG. 7, and optical sensor 700 is shown protected by a sensor lens cover 702. The sensor lens cover 702 is mounted to an actuator 704, that in some embodiments, may be a piezoelectric vibrating element to produce ultrasonic vibrations of the sensor lens cover 702. Such a cleaning modality is effective at removing fluid contamination present on the sensor lens cover 702 by breaking the surface tension between the fluid contaminants and the sensor lens cover 702 such that they fall away by virtue of gravity. Another cleaning system that may be employed in any particular embodiment, is a compressed air system 706 that may be used to remove dirt or other debris from the sensor lens cover 702 by application of a high pressure blast of air 706′. In other embodiments, a pressurized fluid cleaning system 708 may be employed that sprays pressurized cleaning fluid 708′under the sensor lens cover for cleaning. Additionally, the present disclosure contemplates that various cleaning modalities may be used in tandem. For example, the actuator 704 may be activated to produce ultrasonic vibrations on the sensor lens cover 702 while the pressurized air dispenser 706 helps remove water droplets by both the vibratory actions of the actuator 704 and the pressurized air 706′. As another example, the pressurized fluid dispenser 708 may spray the cleaning fluid 708′ onto the sensor lens cover 702 followed by the activation of the pressurized air system 706 to help remove any excess cleaning fluid from the sensor lens cover 702. This operation may have an advantage depending on the camera location as when the vehicle is traveling at low speeds where normal airflow caused by the vehicle moving at higher speeds is not present. Additionally, as shown in FIG. 8, mechanical action such as a wiper arm 800 may move across the sensor lens cover 702 to clean it as indicated by arrow 802. Again, this cleaning modality may be used alone or in combination with the cleaning fluid system 708 in an attempt to clean the sensor lens cover to restore the optical sensor 700 the full operation.

While at least one exemplary aspect has been presented in the foregoing detailed description of the disclosure, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing an exemplary aspect of the disclosure. It being understood that various changes may be made in the function and arrangement of elements described in an exemplary aspect without departing from the scope of the disclosure as set forth in the appended claims.

What is claimed is:

1. A method for cleaning a sensor lens cover for an optical vehicle sensor, comprising:
monitoring, by a processor, the sensor lens cover for a contaminant obstructing at least a portion of the sensor lens cover;
determining, by the processor, presence of the contaminant on the sensor lens cover and a contaminant type of the contaminant using information provided by one or more vehicle sensors;
activating, by the processor, a cleaning modality selected based on the contaminant type; and
determining, by the processor, whether the cleaning modality has removed the contaminant from the sensor lens cover.

2. The method of claim 1, further comprising reactivating, by the processor, the cleaning modality at an increased intensity when the processor determines that the contaminant has not been removed from the sensor lens cover.

3. The method of claim 1, further comprising activating, by the processor, a second cleaning modality different from the cleaning modality when the processor determines that the contaminant has not been removed from the sensor lens cover after the completion of the cleaning modality.

4. The method of claim 1, wherein the sensor lens cover is partitioned into a plurality of cells and the processor further determines which of the plurality of cells are affected by the contaminant.

5. The method of claim 4, wherein each of the plurality of cells has a respective cell weight assigned by the processor and the processor reduces the respective cell weights for any of the plurality of cells that cannot be cleaned by the cleaning modality.

6. The method of claim 5, wherein the processor ignores any of the plurality of cells having a cell weight below a threshold and the processor provides an alert that the sensor lens cover requires service.

7. The method of claim 1, wherein the vehicle sensors providing the information that the processor uses to determine the contaminant type comprise one or more of the following group of vehicle sensors: weather, droplet detector, windshield wiper status, speed, gear position and fluid levels.

8. The method of claim 1, wherein the cleaning modality selected by the processor comprises one of the following group of cleaning modalities: pressurized air, pressurized fluid, mechanical wiping action and ultrasonic vibration.

9. The method of claim 1, wherein the cleaning modality selected by the processor comprises:
when the processor determines the contaminant type to be liquid, one or more of the following group of cleaning modalities: mechanical wiping action, pressurized air and ultrasonic vibration; and
when the processor determines the contaminant type to be solid, pressurized fluid or a combination of pressurized fluid and mechanical wiping action.

10. A system for cleaning a sensor lens cover for an optical vehicle sensor, comprising:
a plurality of vehicle sensors each providing respective sensor information to a processor;
one or more contaminant detectors providing contaminant information to the processor enabling the processor to detect presence of a contaminant on at least a portion of the sensor lens cover;
the processor determining a location of the contaminant on the sensor lens cover and a contaminant type using the sensor information and the contaminant information;
one or more cleaning systems coupled to the processor and responsive to the processor to activate a respective cleaning modality for the sensor lens cover; and
the processor activating a selected cleaning system depending upon the contaminant type and determining whether the contaminate has been removed after the completion of the cleaning modality.

11. The system of claim 10, wherein the processor reactivates the selected cleaning system to reapply the cleaning modality at an increased intensity when the processor determines that the contaminant has not been removed from the sensor lens cover.

12. The system of claim 10, further comprising the processor activating a second cleaning system different from the selected cleaning system when the processor determines that the contaminant has not been removed from the sensor lens cover.

13. The system of claim 10, wherein the sensor lens cover is partitioned in to a plurality of cells and the processor further determines which of the plurality of cells are affected by the contaminant.

14. The system of claim 13, wherein each of the plurality of cells has a respective cell weight assigned by the processor and the processor reduces the respective cell weights for any of the plurality of cells that cannot be cleaned by the cleaning modality.

15. The system of claim 14, wherein the processor ignores any of the plurality of cells having a cell weight below a threshold and the processor provides an alert that the sensor lens cover requires service.

16. The system of claim 10, wherein the plurality of vehicle sensors providing the respective sensor information that the processor receives comprise one or more of the following group of vehicle sensors: weather, droplet detector, windshield wiper status, speed and fluid levels.

17. The system of claim 10, wherein the cleaning modality provided by the selected cleaning system comprises one of the following group of cleaning modalities: pressurized air, pressurized fluid, mechanical wiping action and ultrasonic vibration.

18. The system of claim 10, wherein the selected cleaning system provides the following cleaning modality:
ultrasonic vibration when the processor determines the contaminant type to be liquid; and
pressurized fluid when the processor determines the contaminant type to be solid.

19. A system, comprising:
an optical vehicle sensor having a sensor lens cover partitioned into a plurality of cells;
a plurality of vehicle sensors each providing respective sensor information to a processor;
one or more contaminant detectors providing contaminant information to the processor enabling the processor to detect presence of a contaminant on at least some of the cells of the sensor lens cover;
the processor determining a contaminant type using the sensor information;
one or more cleaning systems coupled to the processor and responsive to the processor to activate a respective cleaning modality for the sensor lens cover; and
the processor activating a selected cleaning system depending upon the contaminant type and then determining whether the contaminate has been removed after the completion of the cleaning modality.

20. The system of claim 19, wherein the processor reactivates the selected cleaning system to reapply the cleaning modality at an increased intensity when the processor determines that the contaminant has not been removed from the sensor lens cover, and the processor activates a second cleaning system different from the selected cleaning system when the processor determines that the contaminant has not been removed from the sensor lens cover by reapplication of the cleaning modality.
